(19) United States
(12) Patent Application Publication
(10) Pub. No.: US 2017/0109894 A1
(43) Pub. Date: Apr. 20, 2017

(54) Kinematic Data Extraction from Technical Videography

(71) Applicant: Caterpillar Inc., Peoria, IL (US)

(72) Inventor: Daniel Waite Uphoff, Carlock, IL (US)

(73) Assignee: Caterpillar Inc., Peoria, IL (US)

(21) Appl. No.: 14/886,692

(22) Filed: Oct. 19, 2015

(51) Int. Cl. G06T 7/20; G06T 7/00; G06T 7/40; H04N 5/225; G06T 5/00

(52) U.S. Cl. CPC G06T 7/20; H04N 5/2256; G06T 5/002; G06T 7/408; G06T 7/0004; G06T 2207/10016; G06T 2207/30241; G06T 2207/30108

(57) ABSTRACT

This disclosure describes a system and a method of extracting kinematic data, the method of extracting kinematic data, the method includes the steps of positioning a camera so that a test component is in a video frame; recording the test component using the camera while the test component is operating to generate video data; measuring kinematic values of a reference component; defining a search region in the video data encompassing an area of the test component; analyzing the measured kinematic values of the reference component; calculating, based on the analyzed kinematic values of the reference component, kinematic values of the test component; and generating an output file containing the calculated kinematic values of the test component.

### TECHNICAL FIELD

This disclosure is generally related to extracting component data from a video. More particularly, this disclosure is related to using a camera to record a reference component and a test component to calculate kinematic values of the test component using data from the reference component.

### BACKGROUND

Machine operators, owners, sellers, and buyers may collect data about various components and machine subsystems for an operating machine. The collected data may be used, for example, to develop better components during the design stage or to understand how the components may be performing in a system. Previously, the data may be collected using data acquisition systems in conjunction with, for example, installed accelerometers, displacement sensors, and other instrumentation. However, this approach presents multiple problems. One such problem is that the equipment may be expensive. For example, the data acquisition system itself may cost tens of thousands of dollars. Another problem is that data acquisition system may take a significant amount of time to setup, calibrate, and validate the equipment. Also, additionally installed equipment may modify the components. For example, the additionally installed equipment may add mass, change the structure, or apply forces to the components that otherwise would not be present during normal operation absent the additionally installed equipment. These modifications may result in inaccurate data, which may impair designing better components or understanding how the components perform in a system.

U.S. Pat. No. 8,843,282 (“the '282 Patent”), entitled “Machine, Control System and Method for Hovering Implement”, is directed to controllably hovering an implement above a substrate. The '282 Patent describes using sensors or cameras to enable monitoring of position, speed, and travel of components. The '282 Patent, however, does not describe using instruments to record, tag, and calculate kinematic values, which may include, for example, position, speed, and travel, of a machine component using a second component as a reference.

Accordingly, there is a need for a system that is configured to calculate kinematic values of a test component without adding instrumentation to the test component.

### SUMMARY

In one aspect of this disclosure, a method of extracting kinematic data, the method includes the steps of positioning a camera so that a test component is in a video frame; recording the test component using the camera while the test component is operating to generate video data; measuring kinematic values of a reference component; defining a search region in the video data encompassing an area of the test component; analyzing the measured kinematic values of the reference component; calculating, based on the analyzed kinematic values of the reference component, kinematic values of the test component; and generating an output file containing the calculated kinematic values of the test component.

In another aspect of this disclosure, a system for extracting kinematic data, the system includes a machine including a test component; a camera configured to record the test component in a video frame; a computer processor configured to execute computer-executable instructions, the computer-executable instructions include defining a search region in the video data encompassing an area of the test component; analyzing measured kinematic values of a reference component; calculating, based on the analyzed kinematic values of the reference component, kinematic values of the test component; and generating an output file containing the calculated kinematic values of the test component.

### BRIEF DESCRIPTION OF THE DRAWINGS

FIG. 1 is a side view of a machine, according to one aspect of this disclosure.

FIG. 2 is a block diagram of a computing system, according to one aspect of this disclosure.

FIG. 3 is an isometric view of an engine/transmission assembly including the reference component and the test component as seen by the camera, according to one aspect of this disclosure.

FIG. 4 shows a close-up view of a test component, according to one aspect of this disclosure.

FIG. 5 is a flowchart of a method of operation of the computing system of FIG. 2, according to one aspect of this disclosure.

### DETAILED DESCRIPTION

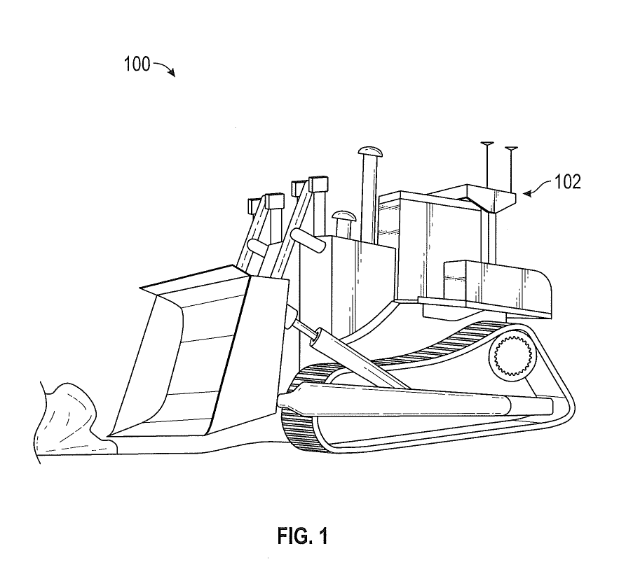

Now referring to the drawings, wherein like reference numbers refer to like elements, there is illustrated in FIG. 1 a perspective view of a system 100, according to an aspect of this disclosure. The system 100 may include a machine 102 powered by an internal combustion engine adapted to burn a fuel to release the chemical energy therein and convert the chemical energy to mechanical power. The machine can be an “over-the-road” vehicle such as a truck used in transportation or may be any other type of machine that performs some type of operation associated with an industry such as mining, construction, farming, transportation, or any other industry known in the art. For example, the machine may be an off-highway truck, a locomotive, a marine vehicle or machine, an earth-moving machine, such as a wheel loader, an excavator, a dump truck, a backhoe, a motor grader, a material handler, a dozer, or the like. The term “machine” may also refer to stationary equipment like a generator that is driven by an internal combustion engine to generate electricity. The specific machine illustrated in FIG. 1 is a bulldozer.

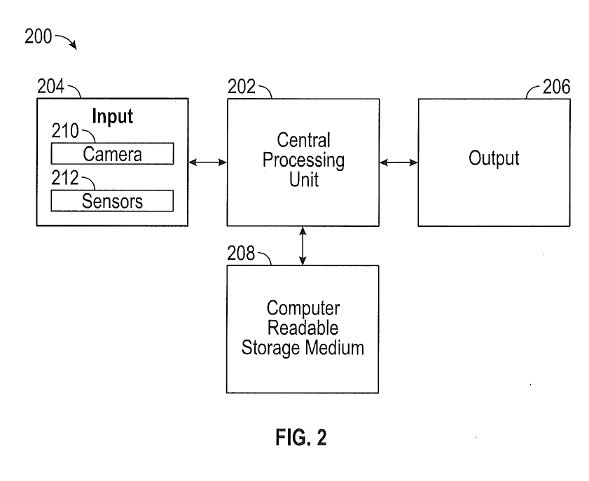

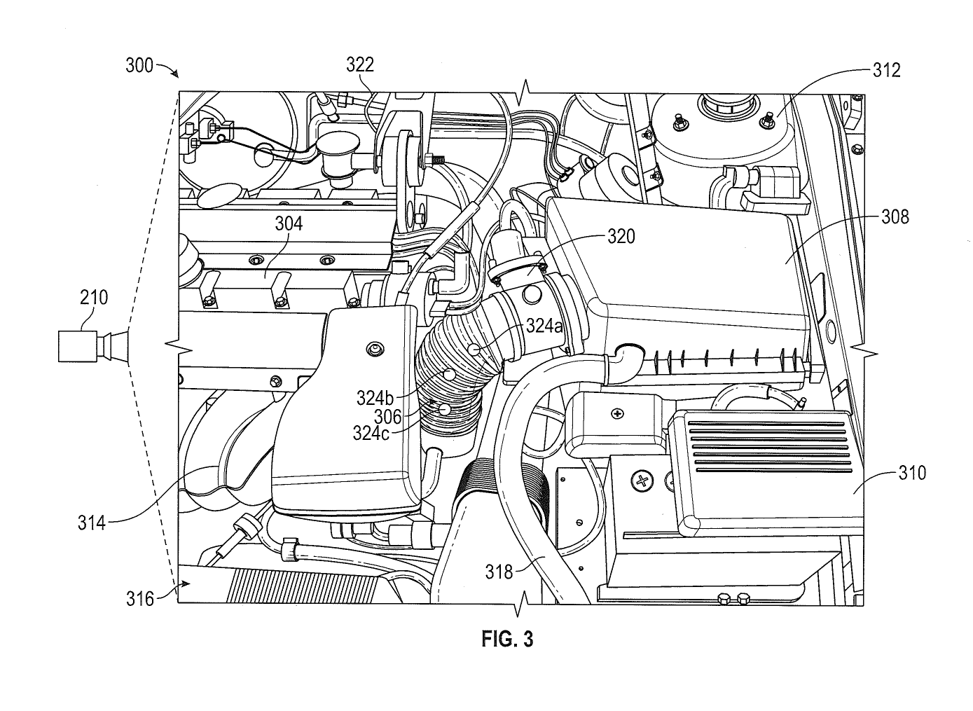

The machine 102 may have multiple components or subsystems, including a reference component 304 (shown in FIG. 3), for example, an engine and a test component 306 (shown in FIG. 3), for example, a bellows. The reference component 304 may have one or more sensors 212 (shown in FIG. 2) coupled to it. The one or more sensors 212 may sense various kinematic values of the reference component 304, such as position, velocity, acceleration, and vibration. Examples of sensors 212 that may be coupled to the reference component 304 include capacitive displacement sensors, inclinometers, accelerometers, tilt sensors, and velocity receivers. The test component 306 may not have any sensors 212 coupled to it.

FIG. 2 is a block diagram of a computing system 200, according to one aspect of this disclosure. The computing system 200 may comprise a central processing unit (CPU) 202, a plurality of inputs 204, a plurality of outputs 206, and a non-transitory computer-readable storage medium 208. The inputs 204, the outputs 206, and the non-transitory computer-readable storage medium 208 may all be operatively coupled to the CPU 202.

In one aspect of this disclosure, one input 204 may be a camera 210 (shown in FIG. 3). For example, the camera 210 may be a high speed camera. The camera 210 may record at any suitable frame rate, for example, between 600 and 5,000 frames per second. Generally, the camera 210 records at a frame rate that is at least 2.5 times as fast as the frequency, such as rotations per minute of an engine, of the test component 306. In one aspect, the camera 210 may be configured to record at a frame rate greater than 5,000 frames per second. The camera 210 may be secured to a tripod. Alternatively, the camera 210 may be secured to another component or a frame of the machine 102.

The camera 210 may record in any suitable standard, such as the National television System Committee (NTSC) and Phase Alternating Line (PAL). Additionally, the camera 210 may output a video file in any suitable file format, including RAW file format. The camera 210 may encode video data using any suitable color space, such as red-green-blue (RGB), hue-saturation-value (HSV), or hue-saturation-luminance (HSL). The camera 210 may also record at any suitable resolution, for example, 720 p, 1080 p, and 4 k. The resolution the camera 210 records at may be dependent on a setup of the test component 306 and a position of the camera 210. For example, if the camera 210 is positioned relatively far from the test component 306, the camera 210 may record at a relatively high resolution. If the camera 210 is positioned relatively close to the test component 306, the camera 210 may record at a relatively low resolution. Additionally, depending on the setup of the test component 306 and the position of the camera 210, various lenses may be attached to the camera 210. For example, if the camera 210 is positioned relatively far from the test component 306, then a relatively narrow lens may be used.

If the camera 210 is positioned relatively close to the test component 306, then a relatively wide lens may be used.

The camera 210 may be positioned in any orientation relative to the reference component 304 and the test component 306 as long as the camera 210 may record the test component 306 with sufficient resolution and the reference component 304 and the test component 306 are both in the same video frame 322. In one aspect of this disclosure, the camera 210 may be positioned so that it is orthogonal to the test component 306. Positioning the camera 210 so that it is orthogonal to the test component 306 may allow the test component 306 to be off-center in a video frame 322. Alternatively, the camera 210 may be positioned so that it is not orthogonal to the test component 306.

In one aspect, multiple reference points may be used to calculate the geometry of the test component 306. For example, the test component 306 may be a tube. The camera 210 may be positioned at one end of the tube and look into the tube. Such a positioning may result in the tube appearing relatively wide on one side, for example the left side, of the video frame 322 while appearing relatively narrow on another side, for example the right side, of the video frame 322. Thus, the distance represented by one pixel on the left side of the video frame 322 may be an order of magnitude smaller than the distance represented by one pixel on the right side of the video frame 322. To compensate for the non-orthogonal positioning of the camera 210, multiple reference points, for example three, may be used. The less orthogonal the camera 210 is to the test component 306, the more reference points may be needed. Otherwise, there may be increased uncertainty in the collected data. The video data recorded by the camera 210 may be transmitted to the CPU 202.

Another example of an input 204 may be a plurality of sensors 212, such as an accelerometer, a displacement sensor, or a passive infrared (PIR) motion sensor. The sensors may have been previously coupled, such as during manufacturing, to the reference component 304, such as an engine. Alternatively, a user may couple the sensors 212 to the reference component 304 after it has been manufactured. The sensors 212 may sense data, such as kinematic values, such as position, velocity, acceleration and vibration, about the reference component 304. The sensors 212 may transmit the sensed information to the CPU 202. The CPU 202 may use the transmitted sensor data to calculate kinematic values of the test component 306, as described herein.

The CPU 202 may receive as inputs data from the plurality of inputs 204, such as video data from the camera 210, sensor data from the sensors 212 located on, for example, the reference component 304, and user input via a keyboard and mouse. The CPU 202 may execute instructions received from the user on the video data received from the camera 210, the sensor data, or both. The CPU 202 may utilize the non-transitory computer-readable storage medium 208 as needed to execute instructions according to an aspect of this disclosure. The non-transitory computer-readable storage medium 208 may store computer-executable instructions to carry out an aspect of this disclosure.

The output 206 may be an output device, such as a display. The output 206 may receive data from the CPU 202. The data may include sensed kinematic values of the reference component 304 and calculated kinematic values of the test component 306. The kinematic values may include, for example, position, velocity, acceleration, frequency, rotation, vibration, and bending of the reference component 304 and the test component 306. The received data may also include video data recorded by the camera 210. The output 206 may be located within a cab of the machine 102. Alternatively, or additionally, the output 206 may be located at a site remote from the machine 102, the reference component 304, and the test component 306, for example a design lab.

FIG. 3 shows an engine/transmission assembly 300 including the reference component 304 and the test component 306 as seen by the camera 210, according to one aspect of this disclosure. FIG. 3 shows some components of the engine/transmission assembly 300, such as an air intake component 308, a battery 310, a suspension mount 312, an exhaust manifold 314, a radiator fan 316, a breather tube 318, and an air mass flow sensor 320. For purposes of this description, the reference component 304 is an internal combustion engine and the test component 306 is a bellows. However, it should be noted that any component of the machine 102 may be used as the reference component 304 and the test component 306, including, for example, those listed above and shown in FIG. 3.

The camera 210 may be positioned so that both the reference component 304 and the test component 306 are viewable in the video frame 322. The test component 306 may have a plurality of color contrast locations 324a, 324b, 324c to provide contrast in the video frame 322. Three color contrast locations 324a, 324b, 324c are shown in FIG. 3. However, any suitable number of color contrast locations may be used on the test component 306. The color contrast locations 324a, 324b, 324c may be, for example, a colored dot, such as a pink dot, or a colored sticker, such as a pink sticker. Any color that provides sufficient contrast with the test component 306 may be used for the dots or stickers. Additionally, mechanisms other than dots and stickers may be used to provide contrast in the video frame 322.

Distance measurements within the video frame 322 may be calibrated. For example, distance measurements may need to be calibrated so that when the video data is processed at the CPU 202, a length a number of pixels may represent may be scaled to a distance. The distance measurements may be calibrated, for example, by using a ruler. The ruler may be inserted into the video frame 322. The camera 210 may then record the ruler, the reference component 304, and the test component 306. The ruler may be removed while the camera 210 is recording. Alternatively, the ruler may be inserted near the end of the recorded video. Once the video has been recorded, the video data may be transmitted from the camera 210 to the CPU 202 for further processing.

In one aspect of this disclosure, an artificial light source, for example a spotlight, may be used to illuminate the image in the video frame 322. An artificial light source may be used if the ambient light inadequately illuminates the reference component 304 and the test component 306. Additionally, an artificial light source may be used if the camera 210 is recording at a sufficiently high frame rate. For example, an artificial light source may be included if the camera 210 is recording at a frame rate at or greater than 2,000 frames per second. An artificial light source may be required in this aspect because the shutter speed may prevent sufficient light from reaching a camera sensor. An artificial light source may be required in this aspect even if there would otherwise be sufficient ambient light if the camera 210 was recording at a slower frame rate.

The camera 210 may begin recording the reference component 304 and the test component 306 when the components 304, 306 begin to operate. While the camera 210 may be recording the reference component 304 and the test component 306, sensors 212 may sense kinematic data about the reference component 304. The sensors 212 may transmit the sensed kinematic data to the CPU 202 for further processing.

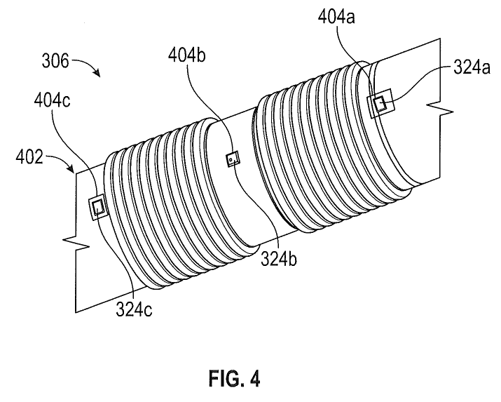

FIG. 4 shows a close-up view of a test component 306, according to one aspect of this disclosure. Like FIG. 3, the test component 306 in this example is a bellows. Also shown in FIG. 4 are three color contrast locations 324a, 324b, 324c.

The CPU 202 may use the recorded video data and the sensed kinematic data of the reference component 304 to calculate kinematic data for the test component 306. The CPU 202 may process the video data so that the video data are in a format that may be displayed on output 206. The output 206 may display an image that is similar to the video frame 322.

Once the video data has been recorded, the user may process the video data with video processing software. The user may examine the video data to determine if the video quality is sufficient to carry out one or more aspects of this disclosure. If the video quality is not sufficient, the user may use the camera 210 again to record video data of sufficient quality. Additionally, or alternatively, the user may examine the video data and determine which portions of the video data are necessary and which may be ignored. The portions of the video data which may be ignored may be removed. Additionally, or alternatively, the user may use the software to filter or sharpen the image in the video frame 322. The user may do this, for example, to lower the computational power needed to carry out aspects of this disclosure.

Using an input 204, such as a keyboard and mouse, a user of the computing system 200 may define a search region 402 for the test component 306. The search region 402 may define an area of interest of the test component 306. In FIG. 4, the search region 402 encompasses the three color contrast locations 324a, 324b, 324c. However, in another aspect of this disclosure, the search region 402 need not encompass all color contrast locations 324a, 324b, 324c. In another aspect, a user may define a signature region 404a, 404b, 404c. In FIG. 4, there are three signature regions 404a, 404b, 404c but any suitable number of signature regions may be used. For example, a signature region may be defined for each color contrast location 324a, 324b, 324c. The user may define a signature region 404a, 404b, 404c around an area of the video frame 322 with high or unique contrast. The size of the signature regions 404a, 404b, 404c may be any suitable size. In one aspect of this disclosure, each signature region 404a, 404b, 404c may be 6×6 square pixels. However, each of the signature regions 404a, 404b, 404c may not be the same size. Located within each signature region 404a, 404b, 404c may be a center point. While the CPU 202 is processing the video data, the CPU 202 may search the search region 402 for each signature 404a, 404b, 404c. If the CPU 202 locates the signatures 404a, 404b, 404c, then the CPU 202 may re-center the search region 402. The CPU 202 may then process the next video frame 322. In processing the next video frame 322, the CPU 202 may search for the search region 402 in the same location as in the previous video frame 322. For example, the CPU 202 may search for the same arrangement of pixels that was defined by the signature regions 404a, 404b, 404c in the previous video frame 322. Thus, the CPU 202 may process the portion of the video frame 322 that includes the search region 402 instead of all of the data in the video frame 322. Thus, the processing would be less computing-intensive. The CPU 202 may compare locations of the search region 402 or signature regions 404a, 404b, 404c to calculate the kinematic values of the test component 306.

Once the CPU 202 has tracked the test component 306 using the plurality of color contrast locations 324a, 324b, 324c, the CPU 202 may further process the video data to remove noise. Noise may be added to the video data from several sources. For example, motion from the camera 210, objects blocking or distorting the view between the test component 306 and the camera 210, poor optics of the lens of the camera 210, glare, and light passing over the test component 306 may all contribute noise to the video data. To increase the accuracy of the calculated kinematic values of the test component 306, the CPU 202 may process the video data to minimize or eliminate the added noise.

In one aspect of this disclosure, the CPU 202 may remove noise added by the camera 210. For example, the camera 210 may move, such as by vibrating, while it is recording the reference component 304 and the test component 306. If the camera 210 is moving, it may be difficult to isolate the camera 210 movement from the movement of the test component 306. In one aspect of this disclosure, the CPU 202 may remove noise added by the camera 210 movement by designating the reference component 304 as a component on, for example, the machine 102. In one aspect, any component other than the camera 210 may be designated as the reference component 304.

Any noise introduced by the camera 210 movement, which may be represented as a noise signature, would be added to the movement of both the reference component 304 and the test component 306. The CPU 202 may examine the movement of both the reference component 304 and the test component 306 to determine how much of the movement of both components 304 and 306 is being influenced by the noise signature added by the movement of the camera 210. After determining the noise signature added by the movement of the camera 210, the CPU 202 may remove the noise signature from the movement of the test component 306 by, for example, subtracting it. This aspect of the computing system 200 makes the system 100 more robust. For example, if a camera 210 is relatively insecurely mounted to the machine 102, the camera 210 may experience substantial motion while the machine 102 is operating. This substantial motion may lead to a great amount of noise being added to the video data with the result that the video data may not be useful to calculate kinematic values of the test component 306. However, as described above, the CPU 202 may remove the noise added by the movement of the camera 210. Thus, the computing system 200 may be able to use the video data to calculate kinematic values of the test component 306 that it otherwise would not have been able to.

In another aspect of this disclosure, the CPU 202 may compensate for distortion introduced by the camera lens. For example, the CPU 202 may compensate for parallax effects. By compensating for parallax effects, the kinematic values generated by the CPU 202 may be improved. For example, compensating for parallax effects for a test component 306 that is large may be beneficial because the parallax effects may have a greater influence on the generated kinematic values of the test component 306.

In another aspect of this disclosure, the computing system 200 may calculate an uncertainty value. The uncertainty value may be used to determine how accurately the CPU 202 has identified the search region 402 and/or the signature regions 404a, 404b, 404c. If the uncertainty value is too high, then the collected data may be bad. For example, the collected data may have too much noise or distortion to properly calculate the kinematic values of the test component 306. The computing system 200 may be able to compensate or remove from the video data the noise or distortion so that the video data is still usable. However, other types of noise or distortion, such as noise or distortion from lighting, may not be able to be compensated for by the computing system 200.

The computing system 200 may determine, using the uncertainty value, how certain it is that the computing system 200 found the signature regions 404a, 404b, 404c. A user of the computing system 200 may compare the uncertainty value with the data to determine whether the uncertainty value is correct. For example, if there is a steep and sudden drop-off in the certainty, then the user may determine that the data is bad. For example, the test component 306 may be obstructed. Additionally, or alternatively, the computing system 200 may determine that the data is bad.

In another aspect of this disclosure, the computing system 200 may be able to calculate kinematic values of the test component 306 even if the view of the test component 306 becomes obstructed. For example, during operation of the machine 102, the view of the test component 306 may become obstructed by material, such as loose earth or mud. The computing system 200 may compensate for the obstructed view. For example, if the computing system 200 knows the dimensions or geometry of the test component 306, the computing system 200 may use reference points around the obstruction to calculate the kinematic values of the test component 306.

### INDUSTRIAL APPLICABILITY

This disclosure describes a system for calculating kinematic values of the test component 306 by referencing the kinematic values of the reference component 304 using a camera 210. The results of calculating the kinematic values of the test component 306 may be used to, for example, develop better parts. In one aspect, the system may be used to determine if the test component 306 is performing according to its specification. Thus, the system may be used to determine whether the design of the test component 306 is deficient in some way or if the user of the test component 306 modified it and the modification resulted in the test component not behaving according to its specification. In another aspect, the system may be used to test the test component 306 if it is a new component. For example, the test component 306 may be a first of its kind component. The system may be used to understand failures or deficiencies of the test component 306 in actual operation. The design of the test component 306 may be modified in response to the results of the test.

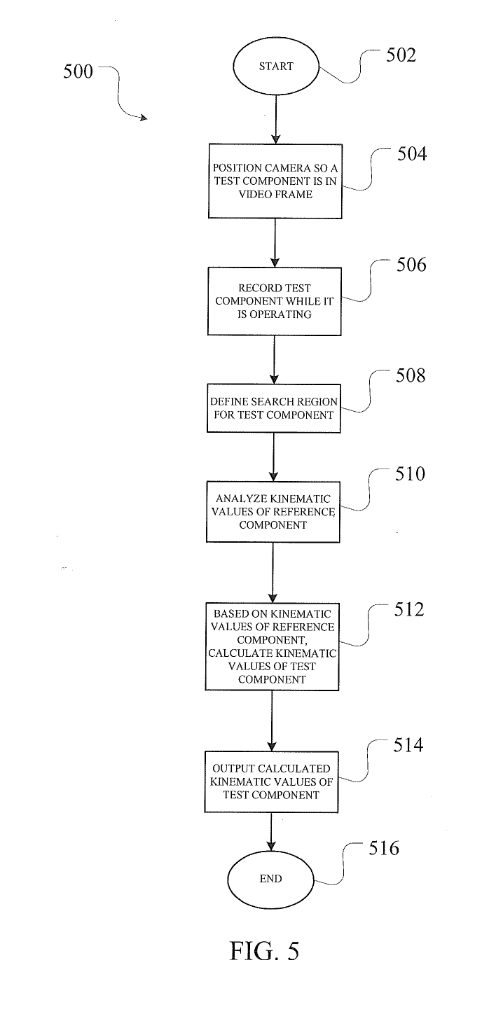

FIG. 5 is a flowchart of a method 500 of operation of the system, according to one aspect of this disclosure. The method 500 may begin at 502 and proceed to 504.

At 504, the camera 210 may be positioned so that the reference component 304 and the test component 306 are both within the video frame 322. During this step, the user of the system may also place color contrast locations 324a, 324b, 324c on the test component 306 as points of contrast in the images recorded by the camera 210. Additionally, or alternatively, the user of the system may utilize an artificial light source, such as a spotlight, to illuminate the reference component 304 and the test component 306 if, for example, natural light does not provide sufficient illumination or if the camera 210 is recording at a frame rate that does not provide adequate time for the camera 210 to expose the image. After completing 504, the method may proceed to 506.

At 506, the camera 210 may record the reference component 304 and the test component 306 while the components 304 and 306 are operating. During this step, the user may insert a measuring instrument, such as a ruler, into the video frame 322. The measuring instrument may be used during the processing of the video data by the CPU 202 to correlate how much distance is represented by a pixel. After completing 506, the method may proceed to 508.

At 508, the user may define a search region 402 on the test component 306. The search region 402 may encompass the color contrast locations 324a, 324b, 324c. Further, the user may define one or more signature regions 404a, 404b, 404c within the search region 402. The signature regions 404a, 404b, 404c may each encompass a single color contrast location 324a, 324b, 324c. After completing 508, the method may proceed to 510.

At 510, the computing system 200 may analyze the kinematic values of the reference component 304. The kinematic values of the reference component 304 may be the result of sensors 212 coupled to the reference component 304. Kinematic values related to the position, velocity, acceleration, or bend of the reference component 304 may be analyzed. After 510 is completed, the method may proceed to 512.

At 512, the computing system 200 may utilize the kinematic data analyzed in 510 to calculate the kinematic data of the reference component 304. For example, the computing system 200 may use the kinematic data of the reference component 304 to calculate the position of the test component 306. After calculating the position of the test component 306, the computing system 200 may calculate the velocity, acceleration, or bend of the test component 306. For example, the computing system 200 may calculate the velocity and acceleration of the test component 306 by taking the first and second derivatives respectively of the position of the test component 306. After completing 512, the method may proceed to 514.

At 514, the computing system 200 may output the calculated kinematic values of the test component 306. The computing system 200 may output an output file containing the kinematic data of the reference component 304 and/or the test component 306. The computing system 200 may output the kinematic values to a display. The display may be located onboard the system 100, for example, in the operator's cab. Alternatively, or additionally, the kinematic values may be displayed on a display located remotely from the system 100, such as a testing laboratory. After completing 514, the method may end at 516.

For the purposes of this disclosure a computer readable medium stores computer data, which data can include computer program code that is executable by a processor of the SIM or mobile device, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and nonremovable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage media, magnetic cassettes, magnetic tape, magnetic disk storage or other magnetic storage devices, or any other physical or material medium which can be used to tangibly store the desired information or data or instructions and which can be accessed by a processor or computing device. In one or more aspects, the actions and/or events of a method, algorithm or module may reside as one or any combination or set of codes and/or instructions on a computer readable medium or machine readable medium, which may be incorporated into a computer program product.

In an embodiment, the present disclosure may be implemented in any type of mobile smartphones that are operated by any type of advanced mobile data processing and communication operating system, such as, e.g., an Apple iOS operating system, a Google Android operating system, a RIM Blackberry operating system, a Nokia Symbian operating system, a Microsoft Windows Mobile operating system, a Microsoft Windows Phone operating system, a Linux operating system, or the like.

Further in accordance with various aspects of the present disclosure, the methods described herein are intended for operation with dedicated hardware implementations including, but not limited to, microprocessors, PCs, PDAs, SIM cards, semiconductors, application specific integrated circuits (ASIC), programmable logic arrays, cloud computing devices, and other hardware devices constructed to implement the methods described herein.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

I claim:

1. A method of extracting kinematic data, the method comprising the steps of:
positioning a camera so that a test component is in a video frame;
recording the test component using the camera while the test component is operating to generate video data;
measuring kinematic values of a reference component;
defining a search region in the video data encompassing an area of the test component;
analyzing the measured kinematic values of the reference component;
calculating, based on the analyzed kinematic values of the reference component, kinematic values of the test component; and
generating an output file containing the calculated kinematic values of the test component.

2. The method of claim 1, wherein:
the calculating step includes the step of comparing a change in position of the search region from one video frame to a next video frame.

3. The method of claim 1, further comprising:
defining a plurality of signature regions within the search region on the test component.

4. The method of claim 3, wherein:
the test component has a plurality of color contrast locations; and
each signature region encompasses a color contrast location.

5. The method of claim 1, further comprising:
illuminating the test component.

6. The method of claim 1, wherein
the reference component is the camera.

7. The method of claim 1, further comprising the steps of:
inserting a measuring device into the video frame, thereby determining a length of a pixel of the camera.

8. The method of claim 1, wherein:
the positioning step includes the step of positioning the camera orthogonally to the test component.

9. The method of claim 1, further comprising:
determining a noise signature of the camera; and
removing noise from video data generated by the camera by subtracting the noise signature from movement of the test component.

10. The method of claim 1, wherein:
positioning the camera so that the reference component is in the video frame.

11. A system for extracting kinematic data, the system comprising:
a machine including a test component;
a camera configured to record the test component in a video frame;
a computer processor configured to execute computer-executable instructions, the computer-executable instructions comprising:
defining a search region in the video data encompassing an area of the test component;
analyzing measured kinematic values of a reference component;
calculating, based on the analyzed kinematic values of the reference component, kinematic values of the test component; and
generating an output file containing the calculated kinematic values of the test component.

12. The system of claim 11, wherein:
the calculating is performed by comparing a change in position of the search region from one video frame to a next video frame.

13. The system of claim 11, wherein the computer-executable instructions further comprise:
defining a plurality of signature regions within the search region on the test component.

14. The system of claim 13, wherein:
the test component has a plurality of color contrast locations; and
each signature region encompasses a color contrast location.

15. The system of claim 11, further comprising:
a light source positioned to illuminate the test component.

16. The system of claim 11, wherein:
the reference component is the camera.

17. The system of claim 11, further comprising:
a measuring device positioned so that it is within the video frame; and
the computer-executable instructions further comprise:
determining a length of a pixel of the camera represents based on the measuring device.

18. The system of claim 11, wherein:
the camera is positioned orthogonally to the test component.

19. The system of claim 11, wherein the computer-executable instructions further comprise:
determining a noise signature of the camera; and
removing noise from video data generated by the camera by subtracting the noise signature from movement of the test component.

20. The system of claim 11, wherein:
the camera is positioned so that the reference component is in the video frame.
